(19) United States
(12) Patent Application Publication
(10) Pub. No.: US 2007/0163850 A1
(43) Pub. Date: Jul. 19, 2007

(54) Aerodynamic Bicycle Disc Wheel Assembly

(76) Inventors: Brad J. Addink, Sun Prairie, WI (US); William E. Miller, Sun Prairie, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/622,200

(22) Filed: Jan. 11, 2007

Related U.S. Application Data
(60) Provisional application No. 60/759,836, filed on Jan. 18, 2006.

(51) Int. Cl. B60T 1/06

(52) U.S. Cl. 188/18 A; 188/218 R

(57) ABSTRACT

An aerodynamic disc wheel assembly includes a pair of generally symmetrical hourglass shaped sidewalls extending from a hub to a brake engaging portion of a wheel. The sidewalls include a radially inwardly positioned widened hub portion, a radially outwardly disposed brake engaging portion, and a two part central portion extending between the hub portion and the brake engaging portion. The assembly further includes an oval shaped end cap for engaging the disc wheel to spinningly receive a bicycle hub.

### CROSS-REFERENCE TO RELATED APPLICATIONS

This application is a non-provisional application and claims priority to provisional application U.S. Ser. No. 60/759,836 filed on Jan. 18, 2006 titled “Aerodynamic Disc Wheel and End Cap”, the disclosure of which is expressly incorporated herein.

### BACKGROUND OF THE INVENTION

1. Field of the Invention

The present invention relates to bicycle wheels and, more specifically, to an aerodynamic disc wheel assembly having an hourglass shaped cross-section. The disc wheel assembly includes a pair of sidewall portions that are constructed to extend between a rim and a hub shell. A portion of the cross-section of the sidewall portions is narrower than a width of a pair of brake walls of the rim and enhances the aerodynamic function of the wheel. The invention further includes an aerodynamic end cap configured to fit over the hub shell and constructed to compliment the aerodynamic function of the disc wheel assembly.

2. Discussion of the Related Art

Several different forces oppose the movement of a bicycle in use. A major force acting against the movement of the bicycle is the drag induced by the bicycle's movement through the air. Although this force is not particularly problematic for recreational riders, the drag forces are problematic to athletic or other professional riders. The faster the movement of a bicycle, the greater the drag force becomes. Greater drag requires the rider to expend greater energy to overcome the drag and detrimentally affects timed rider performance. Accordingly, reducing the drag forces is an important consideration in competitive cycling.

A major source of drag on a bicycle results from the flow of air over and around the bicycle wheels. Prior art bicycle wheels have attempted to reduce drag through the use of a solid faced or “disc” wheel. Disc wheels commonly have no spokes or least provide an aerodynamic cover over the spokes. Although, disc wheels substantially reduce or eliminate drag caused by the movement of air over and around the spokes as well as over and around the rim of the wheel, known disc wheel construction have several drawbacks. The disc wheel typically has a center hub for mounting the wheel to a bicycle frame, a radially outwardly facing rim or tire engaging portion, and first and second opposed, radially extending, axially facing side surfaces or sidewalls. The sidewalls are disc-shaped, have no significant open spaces, and extend between the hub and the tire engaging surface.

Despite the apparent drag reducing advantage of solid wheels, many riders feel that the disadvantages inherent in such a structure render a solid wheel unsatisfactory. Crosswind loading of the disc wheels can compromise the handling of the bicycle. Additionally, some disc wheels are hollow or partially hollow to reduce the weight of the wheel. In many cases these lighter hollow wheels lead to an increase in lateral deflection of the wheel. This lateral deflection can also compromise bicycle handling.

In addition to the compromises in handling discussed above, another important consideration to disc wheel construction is the performance of the disc wheel at operating conditions most frequently experienced by riders. Commonly, during use, a rider will experience various wind angles. A majority of the wind experienced by riders occurs at an attack angle of 10 and 20 degrees. While some disc wheels provide some reduction in drag associated with wind within this range, the disc wheel constructions are not constructed to maximize the drag reduction associated with winds within this range. Accordingly, many riders refuse to utilize such disc wheel assemblies because the disadvantages associated with operation of a bicycle equipped with such disc assemblies out-weighs the uncertain benefits of using such disc assemblies.

Accordingly, a need exists for a bicycle disc wheel assembly with improved aerodynamic function, drag resistance, and lateral stability. It is further desired to provide a disc wheel assembly that is constructed to provide a maximum aerodynamic benefit during the most common conditions experienced by a rider. It is also desired to provide a disc wheel assembly that is robust and lightweight.

### BRIEF DESCRIPTION OF THE INVENTION

The present invention is directed to a bicycle disc wheel assembly that solves the aforementioned problems. In view of the foregoing, one aspect of the present invention provides a disc wheel assembly with increased aerodynamics and lateral stability. Another aspect of the invention provides a disc wheel that exhibits improved aerodynamic efficiency and lateral stability yet is lightweight when compared to wheels of similar shape and weight.

Consistent with the foregoing aspects and in accordance with the invention as embodied and broadly described herein, an aerodynamic disc wheel and an end cap for a disc wheel are disclosed in suitable detail to enable one of ordinary skill in the art to make and use the invention.

According to one aspect of the invention, an aerodynamic disc wheel assembly is disclosed that includes a pair of symmetrical hourglass shaped sidewalls extending from a hub to a brake engaging portion of the wheel. The sidewalls include a radially inwardly positioned widened hub portion, a radially outwardly disposed generally planar portion proximate the brake engaging portion, and a two part central portion extending between the hub portion and the brake engaging portion. The central portion includes a first section curving inwardly from a widest point to a narrowest point and a second section curving outwardly from the narrowest point to the brake engaging portion.

In one embodiment, the narrowest point may be between 50-60% of the width of the widest point. In another embodiment the narrowest point is between 50-55% of the width of the widest point. Alternatively, the narrowest point may be between 80-90% the width of the brake engaging portion. In still another embodiment, the narrowest point is between 85-90% the width of the widest point.

In accordance with another aspect of the invention an end cap for a disc wheel is disclosed.

The end cap includes an outer oval shaped front wall defining a through bore configured to receive an axle, and a radially outwardly facing side wall extending from an edge of the front wall and tapering inward to define a forward face and a rear face. The end cap defines a space behind the forward face to spinningly receive a bicycle hub. The oval shaped end cap is constructed to engage the disc wheel assembly for enhancing the aerodynamic function of the overall wheel assembly.

Various other features, aspects, and advantages of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an elevational view of a bicycle equipped with a disc wheel assembly according to the present invention;

FIG. 2 is an elevational view of the disc wheel assembly shown in FIG. 1;

FIG. 3 is a cross-sectional view of the disc wheel assembly along line 3-3 shown in FIG. 2;

FIG. 4 is a detailed cross-sectional view of a rim area of the disc wheel assembly along line 4-4 shown in FIG. 3;

FIG. 5 is a detailed cross-sectional view of a hub area of the disc wheel assembly along line 5-5 shown in FIG. 3.

FIG. 6 is a perspective view of an end cap of the disc wheel assembly shown in FIG. 3;

FIG. 7 is a cross-sectional view of the end cap along line 7-7 shown in FIG. 6;

FIG. 8 is a cross-sectional view of the end cap along line 8-8 shown in FIG. 6 and is a view generally transverse to the view shown in FIG. 7;

FIG. 9 is a graph showing the association of wind angle and aerodynamic drag force for the disc wheel assembly shown in FIG. 1 with and without implementation of the end cap shown in FIG. 6; and

FIG. 10 is a graph showing the lateral deflection of the disc wheel assembly shown in FIG. 2 as compared to various known disc wheel assemblies.

In describing the preferred embodiments of the invention that are illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF PREFERRED EMBODIMENTS

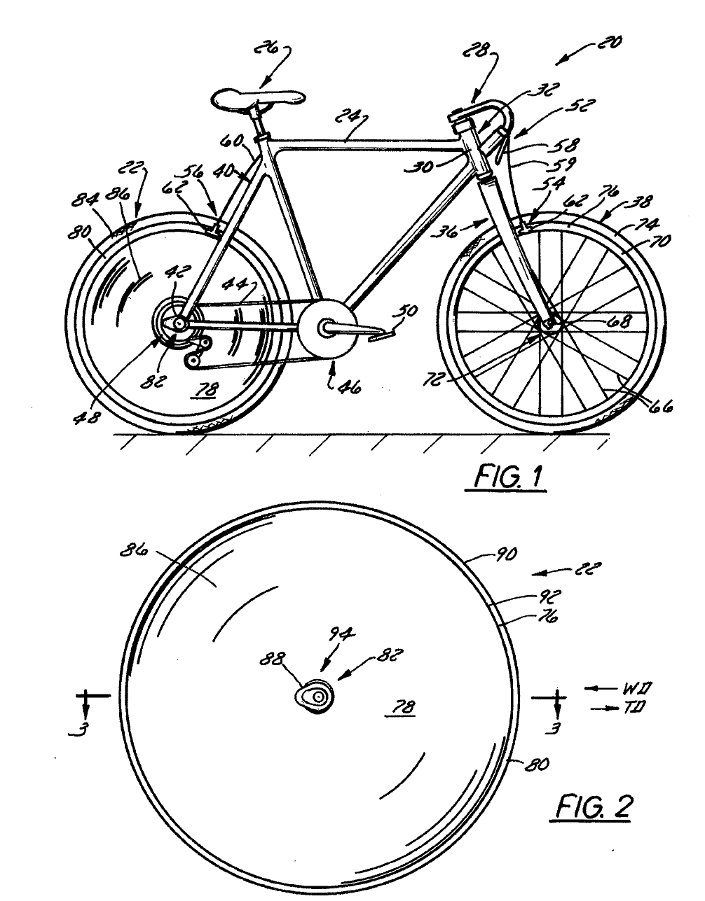

FIG. 1 shows a bicycle 20 equipped with a disc wheel assembly 22 according to the present invention. Bicycle 20 includes a frame 24 having a seat assembly 26 and a handle bar assembly 28 attached thereto. Handle bar assembly 28 is rotationally connected to frame 24 by a head tube 30 positioned at a forward portion 32 of frame 24. Handle bar assembly 28 is secured to a fork assembly 36 which is constructed to receive a front wheel assembly 38. A rear portion 40 of frame 24 engages a rear axle 42 which is constructed to attach disc wheel assembly 22 to bicycle 20. A chain 44 extends between a peddle assembly 46 and a gear assembly 48 attached to disc wheel assembly 22. Understandably, manipulation of peddles 50 of peddle assembly 46 rotates chain 44 thereby driving disc wheel assembly 22.

Bicycle 20 includes a brake system 52 having a front brake assembly 54 and a rear brake assembly 56. A brake handle 58 is attached to handle bar assembly 28 and connected to each brake assembly 54, 56 via a brake cable 59, 60, respectively. Understandably, brake handle 58 can include a pair of separately operable handles to allow independent braking of the front and rear wheels assemblies 22, 38. Actuation of brake handle 58 causes a number of brake pads 62 associated with each of front brake assembly 54 and rear brake assembly 56 to engage the respective wheel assembly to slow or stop motion of the respective wheel assembly 22, 38.

Front wheel assembly 38 includes a number of spokes 66 that extend between a hub 68 and a rim 70. Hub 68 is connected to an end 72 of fork assembly 36 such that front wheel assembly 38 is allowed to rotate freely relative to fork assembly 36. A tire 74 is attached to rim 70 and can include a tube or be tube-less. Rim 70 includes a brake wall 76 on each side thereof. Brake walls 76 are generally aligned with brake pads 62 of front brake assembly 54 such that actuation of brake handle 58 presses the brake pads 62 into the oppositely facing brake walls 76.

Disc wheel assembly 22 forms an aerodynamic disc wheel and includes a disc assembly 78 that extends between a rim 80 and a hub assembly 82. A tire 84 is positioned about rim 80 radially outward from disc assembly 78. Rim 80 includes a pair of oppositely facing brake walls 86 that are also positioned radially outward from disc assembly 78. Gear assembly 48 is attached about rear axle 42 and engages chain 44 to drivingly connect disc wheel assembly 22 to peddle assembly 46. Although bicycle 20 is shown having only a rear disc wheel assembly 22, it is appreciated that front wheel assembly 38 can also be constructed as a disc wheel assembly for those riders who desire such a configuration.

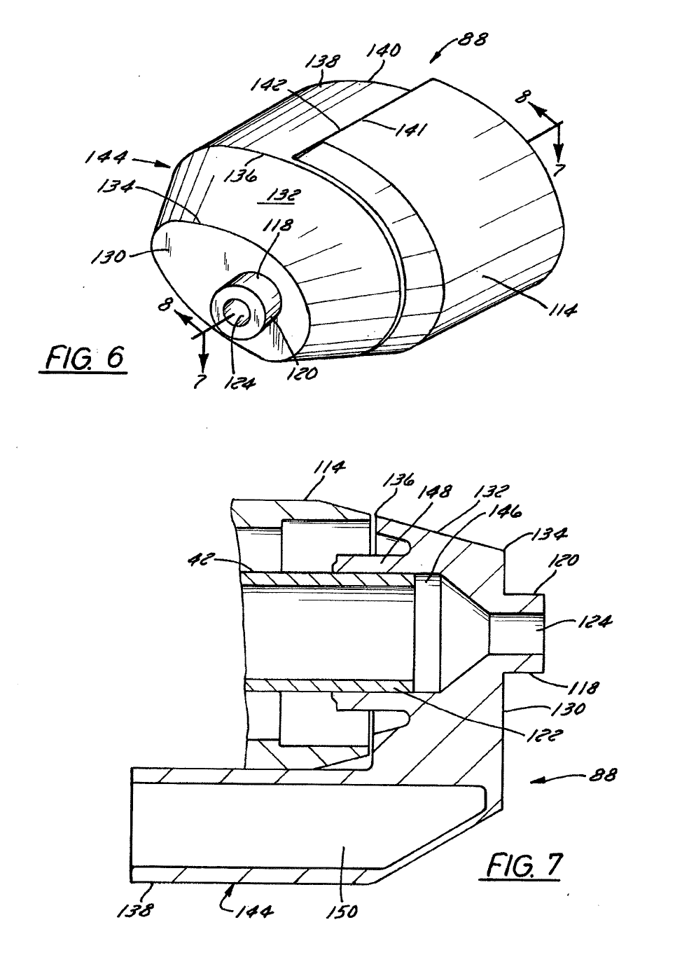

Referring to FIGS. 2-5, disc wheel assembly 22 is shown removed from bicycle 20 with tire 84 removed therefrom. As shown in FIG. 2, an end cap 88 is constructed to engage disc wheel assembly 22 such that the orientation of end cap 88 is maintained during rotation of disc wheel assembly 22. End cap 88 is described further below with respect to FIGS. 6-8. Disc assembly 78 extends between hub assembly 82 to rim 80. A perimeter edge 90 of rim 80 is constructed to sealingly engage a tire thereabout. Brake wall 76 extends generally uniformly about rim 80 proximate edge 90. Disc assembly 78 extends generally continuous from a first end 92 positioned proximate brake wall 76 to a second end 94 positioned proximate hub assembly 82. Such a construction ensures that an airflow, indicated by the arrow “WD” generated during travel in a travel direction, indicated by arrow “TD”, is “cut” by disc wheel assembly 22, travels generally uninterrupted across disc assembly 78, and flows off a trailing edge of disc wheel assembly 22.

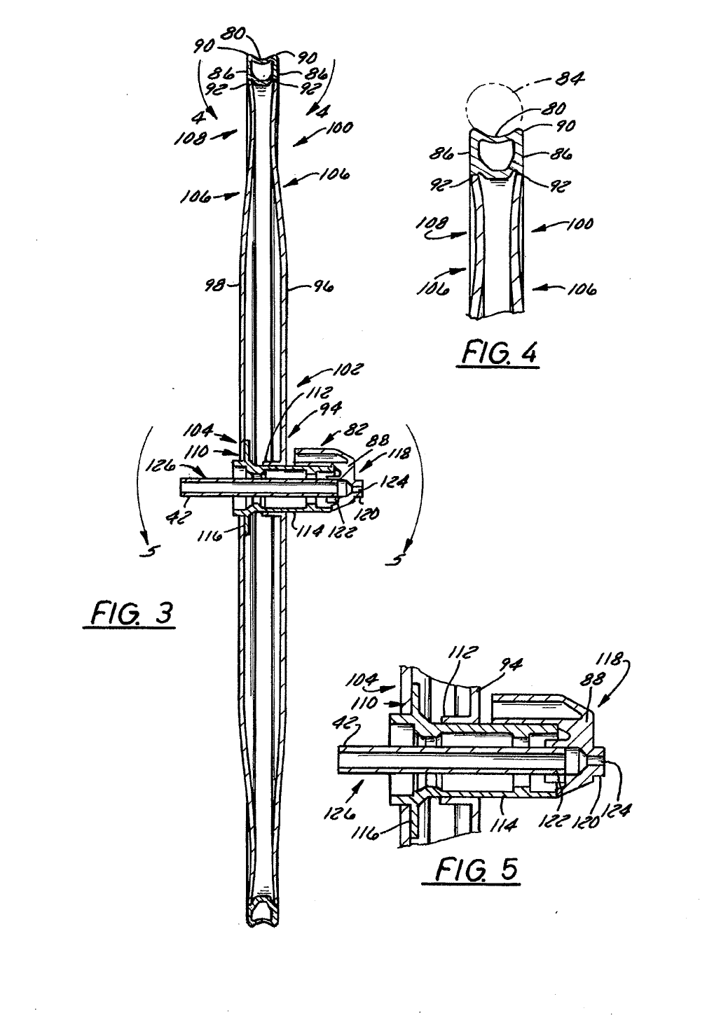

As shown in FIGS. 3-5, disc assembly 78 includes a first sidewall 96 and a second sidewall 98 that each extend between rim 80 and hub assembly 82. Sidewalls 96, 98 are positioned on generally axially-opposed sides of disc wheel assembly 22 and each sidewall has an hourglass or lenticular shaped cross-section. A narrowest cross-sectional area 100 of disc assembly 78 is radially located closer to rim 80 than hub assembly 82. Preferably, narrowest area 100 is approximately 19.5 mm wide. Disc assembly 78 includes a widened hub portion 102 that is located proximate hub assembly 82 relative to narrowest area 100. In the illustrated embodiment, hub portion 102 includes the widest point 104 of disc wheel assembly 22. Widest point 104 is preferably between 0-100 mm from hub assembly 82 on a 700 mm disc wheel. In the illustrated embodiment, widest point 104 of the disc wheel assembly 22 is preferably 36 mm wide. It is understood that the width of widest point 104 could be a variety of widths.

As shown in FIG. 3, disc wheel assembly 22 includes a first section 106 that curves inwardly from widened hub portion 102 to narrowest area 100. Preferably, narrowest area 100 is located from hub assembly 82 approximately ¾ of the total distance between hub assembly 82 and brake walls 86 or between 225-300 mm from hub assembly 82 for a 700 mm disc wheel. A second section 108 of disc wheel assembly curves outwardly as it extends from the narrowest area 100 toward brake wall 86. Preferably, brake wall 86 is generally planar and is disposed adjacent the perimeter edge 90 of rim 80. Preferably, disc assembly 78 is approximately 19.5 mm wide proximate brake wall 86. Alternatively described, sidewalls 96, 98 of disc wheel assembly 22 are hour-glass or lenticular shaped sidewalls that extend inwardly from a widest point 104 proximate hub assembly 82 to a narrowest area 100 that is between about 45-60% the width of the widest point. Preferably, narrowest area 100 is between about 50-55% the width of widest point 104. Progressing radially outward, sidewalls 96, 98 extend axially outwardly from narrowest area 100 to brake walls 86 such that narrowest area 100 is between about 80-95% the distance between oppositely facing brake walls 86. Preferably, the width of narrowest area 100 is between about 85-90% of the distance between oppositely facing brake walls 86.

As best shown in FIG. 4, first ends 92 of sidewalls 96, 98 are attached to rim 80 and are preferably bonded thereto. Each side wall 96, 98 extends generally continuously to a second end 94, 110 that is constructed to engage hub assembly 82. As best shown in FIG. 5, second end 94 of sidewall 96 includes a flange 112 formed thereat. Flange 112 extends generally transverse to the majority of sidewall 96 and is constructed to slidingly engage a hub shell 114. Preferably, flange 112 is constructed to be bonded to hub shell 114. A hub shell flange 116 extends generally perpendicular from the hub shell 114 and is constructed to engage second end 110 of second sidewall 98. Second end 110 of second side wall 98 is preferably formed without a flange and is preferably bonded to hub shell flange 116. Such a construction secures the position of second ends 94, 110 of first and second sidewalls 96,98 relative to hub shell 114.

Disc wheel assembly 22 shown in FIGS. 3-5 may be formed of a variety of different materials including, but not limited carbon fiber, plastic, aluminum or combinations of these and other known materials. Preferably, at least sidewalls 96, 98 are formed from a carbon fiber material. Furthermore, although disc wheel assembly 22 is shown as being hollow, it is appreciated that the cavity between side walls 96, 98 may be filled or partially filled with foam or other materials. Alternatively, disc wheel assembly 22 may contain a combination of filled and hollow spaces and/or spokes. Preferably, disc wheel assembly 22 is hollow and is formed from a carbon fiber composite material. The disc wheel assembly 22 has a structure where the carbon fiber sidewalls 96, 98 define a majority of the wheel's shape and structural strength.

It is further appreciated that the sidewalls 96, 98, hub shell 114, and rim 80, or any combination thereof, be formed as a unitary component of disc wheel assembly 22. That is, it is appreciated that sidewalls 96, 98 may form only the brake walls 86 or the entirety of rim 80. Such a construction would allow sidewalls 96, 98 to directly support a tire and/or include a generally planar brake wall portion. Regardless of the relative termination of sidewalls 96, 98, it is envisioned that brake walls 86 may include a surface coating, or an aggregate dispersion to improve braking characteristics. It is further appreciated that the brake walls 86 and the tire engaging perimeter edge 90 of disc wheel assembly 22 may be made of carbon fiber or from metal-based components, such as aluminum, or a mixture of metal and carbon fiber based components.

As shown in FIGS. 3, 5, and 6-8, end cap 88 of disc wheel assembly 22 is constructed to compliment the aerodynamic function of disc wheel assembly 22. End cap 88 is constructed to slidably engage hub shell 114 such that hub shell 114 is allowed to rotate relative to end cap 88 and axle 42 during rotation of disc wheel assembly 22. End cap 88 includes a nipple 118 formed at an end 120 thereof. End 120 is oriented generally away from disc wheel assembly 22 and is constructed to locate end cap 88 relative to frame 24 of bicycle 20. A first end 122 of axle 42 passes into end cap 88 and is constructed to be generally aligned with an opening 124 forming through nipple 118. A fastener (not shown) passes through opening 124, through axle 42, and is constructed to secure axle 42 to bicycle 20. Another end 126 of axle 42 extends from disc wheel assembly 22 and is constructed to pass through gear assembly 48 as shown in FIG. 1.

As shown in FIGS. 6-8, end cap 88 is generally oval shaped and includes a front wall 130 from which nipple 118 extends. A radially outwardly facing, angled side wall 132 extends from an edge 134 of front wall 130 to a hub shell facing edge 136 of angled side wall 132. A lateral wall 138 extends between hub shell facing edge 136 of angled side wall 132 to a wheel facing end 140 of end cap 88. Lateral wall 138 includes a leading portion 142 constructed to face into an airflow and generally aligned with an outer surface 141 of hub shell 114 and a trailing portion 144 facing generally opposite leading portion 142. Leading portion 142 and trailing portion 144 cooperate with the contour of hub shell 114 to for an airfoil shape about that portion of the hub shell which extends from disc wheel assembly 22. Preferably, leading portion 142 and trailing portion 144 extend approximately ½ of the circumference of hub shell facing edge 136 of end cap 88. The airfoil shaped construction of end cap 88 enhances the aerodynamic drag reducing function of a wheel assembly equipped therewith.

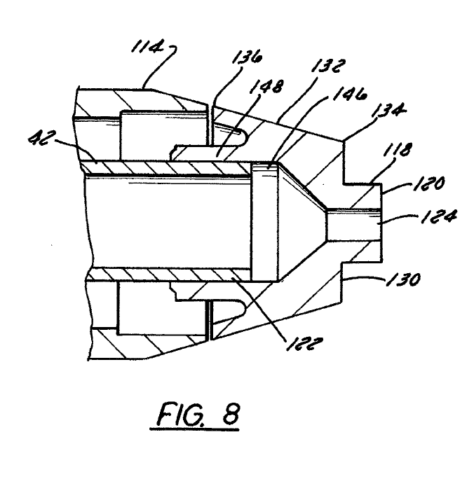

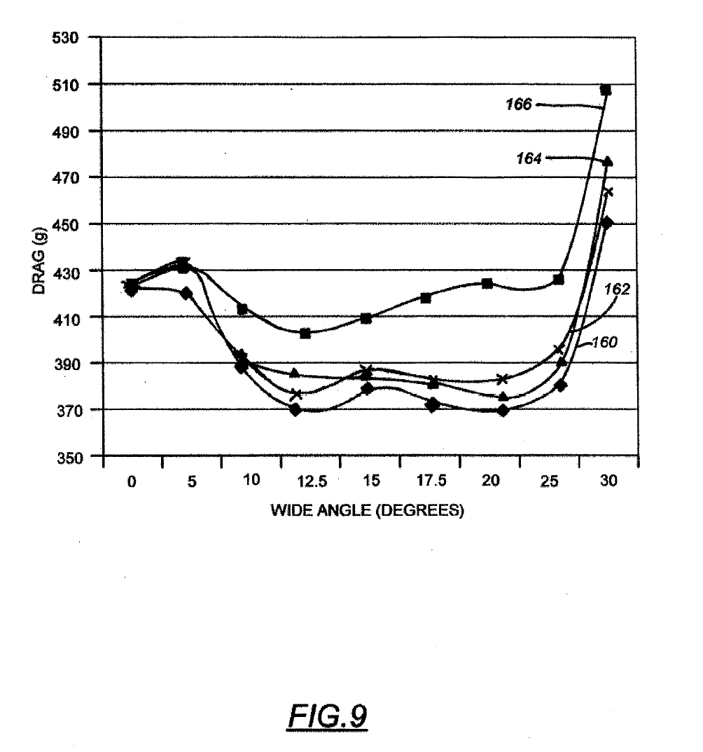

Referring to FIG. 7, end cap 88 includes a first cavity 146 constructed to receive axle 42. A projection 148 extends about cavity 146 and is constructed to secure end cap 88 to a non-rotating component of hub assembly 82. Such a construction maintains the orientation of the airfoil shape of end cap 88 relative to a direction of travel of bicycle 20. A second cavity 150 is formed proximate trailing portion 144 and forms the gradually tapered shape of the trailing edge as shown in FIG. 8. Understandably, end cap 88 can be formed from any material including carbon fiber, metal, plastic, or any combination thereof. It is further appreciated that, rather than allowing hub shell 114 to form the leading edge of the airfoil shape, that end cap 88 be formed to generally encompass that portion of the hub shell which extends beyond disc wheel assembly 22. Such a construction reduces the dependency of the construction of the end cap on the construction of the hub shell and provides an end cap that would be applicable to a variety of wheel assembly constructions.

Generally, as a bicycle is traveling in direction TD, the radially outer edge of a tire connected to a wheel assembly meets the air surrounding the wheel. This air moves relative to wheel assembly in direction WD due to the speed of the bicycle and wheel in direction TD. The air has different velocities, and thus different pressures, around the moving wheel. The air first hits the crown of a tire creating a relatively high pressure area in front of the crown of tire, and the air splits around the crown, and flows with increasing velocity and reduced pressure in the direction WD on both sides of the wheel. At a separation point, the air separates from the sidewalls of a disc equipped wheel and generates a large turbulent flow area starting at the separation point and propagating toward the trailing edge of disc wheel. The turbulent fluid air flow across the disc wheel generates a low pressure wake which results in a reduced pressure area immediately behind the trailing edge of disc wheel. Comparatively, an increased pressure area is generated immediately in front of the leading edge of disc wheel. The pressure differential between the areas proximate the leading and trailing edges of disc wheel slows travel of the wheel and the bicycle and is a primary source of wheel generated drag associated with operation of the bicycle.

The hourglass shaped sidewalls 96, 98 and aerodynamic end cap 88 of disc wheel assembly 22 allow the air flowing in the direction WD relative to the sidewalls 96, 98 to follow the curvature of the sidewalls 96, 98 thereby reducing the pressure differential between the areas proximate the leading and trailing edges of the disc wheel assembly. The airfoil shaped contour of end cap 88 similarly reduces the pressure differential between the leading and trailing edges of that portion of the hub assembly which protrudes relative to sidewalls 96, 98 of disc wheel assembly 22. Accordingly, the aerodynamic end cap further accentuates the aerodynamic performance of any wheel assembly and particularly disc wheel assembly 22. These drag reducing functions of both disc wheel assembly 22 and end cap 88 allows disc wheel assembly 22 to slip through the air with less resistance thereby enabling a rider to either ride more quickly with the same amount of effort, or alternately to ride at the same speed with less effort, when compared to riding a bicycle equipped with known aerodynamic disc wheel constructions.

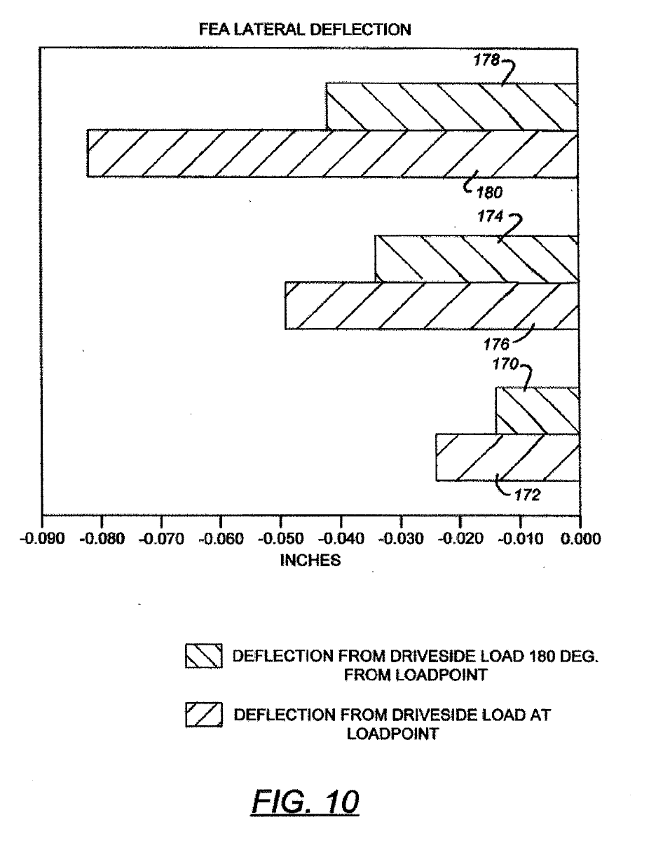

The graphs shown in FIGS. 9 and 10 show results obtained in tests of disc wheel assembly 22 as compared to various prior art types of disc wheels. FIG. 9 shows the drag force generated with various angles of attack between the wheel and the wind direction. Trend 160 shows the drag force measured for disc wheel assembly 22 equipped with end cap 88. Trend 162 shows the drag force measured for a disc wheel assembly 22 without end cap 88. Trend 164 shows the drag force measured with one prior art disc wheel and trend 166 shows the drag force measured with another prior art disc wheel. As shown in FIG. 9, disc wheel assembly 22, whether equipped with or without end cap 88, creates a lower drag force than these known disc wheel types across a majority of the range of the graph. It is further noted that end cap 88 further enhances the aerodynamic function of disc wheel assembly 22. Additionally, it is also noteworthy that the enhanced drag reductions occur between the range of the most frequently encountered wind angles, i.e. wind angles generally between about 10 and 25 degrees.

In additional to the aerodynamic functions discussed above, FIG. 10 shows the improvement in resistance to lateral deflection achieved with disc wheel assembly 22 as compared to prior art disc wheel constructions. FIG. 10 shows the lateral deflection, measured in inches, from a drive side load 180 degrees from a load point and at the load point. Bars 170 and 172 show the lateral deflection of disc wheel assembly 22 during these loadings. Bars 174 and 176 show the lateral deflection of a one prior art wheel and bars 178, 180 show the lateral deflection of another prior art disc wheel subjected to the same finite element analysis and lateral loading as disc wheel assembly 22. The graph illustrates that disc wheel assembly 22 exhibits significantly less lateral deflection than these known disc wheels. Thus, disc wheel assembly 22 not only provides a wheel assembly with enhanced aerodynamic function, but provides a disc wheel assembly that is less susceptible to lateral deflection. Accordingly, disc wheel assembly 22 provides a disc wheel that is highly aerodynamic and less susceptible to the drawbacks associated with lateral deflection.

Therefore, one embodiment of the invention includes an aerodynamic disc wheel assembly having a pair of symmetrical hourglass shaped sidewalls extending from a hub to a brake engaging portion of the wheel. The sidewalls includes a radially inwardly positioned widened hub portion, a radially outwardly disposed generally planar brake engaging portion, and a two part central portion. The two part central portion extends between the hub portion and the brake engaging portion and has a first section that curves inwardly from a widest point to a narrowest point and a second section that curves outwardly from the narrowest point to the brake engaging portion.

Another embodiment of the invention includes an end cap for a disc wheel and has an outer oval shaped front wall defining a through bore configured to receive an axle. The end cap includes a radially outwardly facing side wall that extends from an edge of the front wall and tapers inward to define a forward face and a rear face. The end cap defines a space behind the forward face to spinningly receive a bicycle hub.

A further embodiment of the invention includes a method of forming a bicycle disc wheel assembly. The method includes forming a rim having a width and is constructed for supporting a tire. A pair of disc walls extends between generally opposite sides of the rim to a hub shell such that each disc wall has a lenticular cross-sectional shape that has a widest portion proximate the hub and a narrowest portion offset inwardly from the rim. A first end of each of the disc walls is then attached to the rim and a second end of each of the disc walls is attached to a hub shell.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept. For example, the invention discloses a variety of specific dimensions. However, it is appreciated that these dimensions can be varied such the disc wheel assembly can be attached to bicycles of different dimensions and constructions. Moreover, as noted throughout the application, the individual components need not be formed in the disclosed shapes, or assembled in the disclosed configuration, but could be provided in virtually any shape, and assembled in virtually any configuration, so as to provide for an aerodynamic disc wheel. Furthermore, all the disclosed features of each disclosed embodiment can be combined with, or substituted for, the disclosed features of every other disclosed embodiment except where such features are mutually exclusive. It is intended that the appended claims cover all such additions, modifications and rearrangements. The present invention has been described in terms of the preferred embodiment, and it is recognized that equivalents, alternatives, and modifications, aside from those expressly stated, are possible and within the scope of the appending claims.

What is claimed is:

1. An aerodynamic disc wheel assembly comprising a pair of symmetrical hourglass shaped sidewalls extending from a hub to a brake engaging portion of the wheel the sidewalls comprising:
a radially inwardly positioned widened hub portion
a radially outwardly disposed generally planar brake engaging portion, and
a two part central portion extending between the hub portion and the brake engaging portion, wherein the central portion has a first section that curves inwardly from a widest point to a narrowest point and a second section that curves outwardly from the narrowest point to the brake engaging portion.

2. The assembly of claim 1, wherein the narrowest point is between approximately 50-60% the width of the widest point.

3. The assembly of claim 2, wherein the narrowest point is between approximately 50-55% the width of the widest point.

4. The assembly of claim 1, wherein the narrowest point is between approximately 80-90% the width of the brake engaging portion.

5. The assembly of claim 4, wherein the narrowest point is between approximately 85-90% the width of the widest point.

6. The disc wheel of claim 1 further comprising an end cap configured to fit over the hub, the end cap comprising:
an outer oval shaped front wall defining a through bore configured to receive an axle;
a radially outwardly facing sidewall extending from an edge of the front wall and tapering inward from a forward face to a rear face; and
wherein said end cap defines a space behind the forward face to spinningly receive the hub.

7. An end cap for a disc wheel, the end cap comprising:
an outer oval shaped front wall defining a through bore configured to receive an axle;
a radially outwardly facing side wall extending from an edge of the front wall and tapering inward to define a forward face and a rear face; and
wherein said end cap defines a space behind the forward face to spinningly receive a bicycle hub.

8. The end cap of claim 7 further comprising a nipple extending outwardly from the front wall.

9. The end cap of claim 7 wherein the end cap is constructed to spinningly receive the bicycle hub such that a longer axis of the outer oval shaped front wall is generally aligned with a direction of travel of a bicycle.

10. The end cap of claim 7 further comprising a rear wall constructed to engage a disc of a bicycle wheel such that the disc can rotate relative to the end cap.

11. The end cap of claim 10 wherein the disc further comprises a pair of upstanding walls constructed to extend between a hub and a rim.

12. The end cap of claim 11 wherein the pair of upstanding walls are positioned on generally radially opposite sides of the bicycle wheel and have generally mirror image cross-sections relative to a bisecting plane that is oriented generally perpendicular to an axis of rotation of the bicycle wheel.

13. The end cap of claim 11 wherein each of the pair of upstanding walls further comprises a radially inwardly positioned widened hub portion, a radially outwardly disposed generally planar brake engaging portion, and a central portion extending between the hub portion and the brake engaging portion, wherein the central portion has a first section that curves inwardly from a widest point to a narrowest point and a second section that curves outwardly from the narrowest point to the brake engaging portion.

14. A method of forming a bicycle disc wheel assembly comprising:
forming a rim having a width and for supporting a tire;
extending a pair of disc walls between generally opposite sides of the rim to a hub shell such that each disc wall has a lenticular cross-sectional shape that has a widest portion proximate the hub and a narrowest portion offset inwardly from the rim; and
bonding a first end of each of the disc walls to the rim and a second end of each of the disc walls to a hub shell.

15. The method of claim 14 further comprising forming each of the pair of disc walls from a carbon fiber material.

16. The method of claim 14 further comprising forming a flange proximate the second end of at least one of the disc walls that extends in a direction generally transverse to the disc wall.

17. The method of claim 16 further comprising terminating the second end of the other disc wall without a flange.

18. The method of claim 17 further comprising forming a flange on the hub shell that extends radially outwardly from the hub shell and engages the second end of the other disc wall.

19. The method of claim 14 further comprising forming an end cap having an exterior surface with an airfoil shape.

20. The method of claim 19 further comprising forming an interior surface of the end cap to fixedly engage a non-rotating component of the disc wheel assembly for fixing a position of the end cap relative to a bicycle during use.
